(19) United States
(12) Patent Application Publication
(10) Pub. No.: US 2002/0016849 A1
(43) Pub. Date: Feb. 7, 2002

(54) System, method and accounting method for information delivery

(75) Inventor: Kazuhiko Hayashi, Tokyo (JP)

Correspondence Address: SUGHRUE, MION, ZINN, MACPEAK & SEAS, 2100 Pennsylvania Avenue, N.W., Washington, DC, 20037, US

(73) Assignee: NEC CORPORATION

(21) Appl. No.: 09/918,509

(22) Filed: Aug. 1, 2001

(30) Foreign Application Priority Data
Aug. 3, 2000 (JP) 235968/2000

(51) Int. Cl. G06F 15/16

(52) U.S. Cl. 709/231; 709/204

(57) ABSTRACT

An information delivery system includes an information delivery device, an information communicating means, and an information storage and playback device. The information storage and playback device stores partial information of delivery information beforehand, reproduces one of the stored partial information, and notifies the information delivery device of the partial information chosen to be reproduced. While the information storage and playback device is reproducing the partial information of the delivery information, the information delivery device transmits remaining information of the delivery information, which is chosen to be reproduced by the information storage and playback device, to the information storage and playback device. The information storage and playback device chooses the partial information to reproduce, stores the remaining information of the delivery information transmitted from the information delivery device, and reproduces the stored remaining information of the delivery information just as the reproduction of the partial information is finished. Therefore, it is possible to deliver information smoothly without a pause and any delay.

### BACKGROUND OF THE INVENTION

The present invention relates to a system, a method, and accounting method for information delivery, in which information transmitted from an information delivery device is sent to an information storage and playback device through an information communicating means.

### DESCRIPTION OF THE RELATED ART

Information retrieval by a combination of a conventional computer and the Internet, or information retrieval or information delivery by a combination of a cell phone and the Internet is widely known as an information storage and playback system which basically includes an information storage and playback device that stores information and reproduces it as required, an information communicating means which conveys information to the information storage and playback device, and an information delivery device which transmits information to the information storage and playback device.

In these systems, an information user operates the information storage and playback device which is typified by a computer or a cell phone. Thereby, request information including items of information needed by the user is sent to the information delivery device through an information communicating means, which is typified by the Internet, applying the information storage and playback device and the information delivery device used by an information provider. The information delivery device sorts out information needed by the information user from information in a server, a data base and so forth, sends back the chosen information to the user through the Internet, automatically stores the information in the information storage and playback device operated by the user, and displays the information on a display instrument embedded in the store and playback device.

Also, concerning accounting and payment for the use of information, it is widely known that information is often offered free of charge in the information service on the Internet. There is also information service in which the charge for the use of information is paid, but the timing of carrying out the accounting is unclear.

In a conventional information delivery system, a series of related information needed by a user is sent from an information provider by user's operation of a computer or a cell phone. In the system suchlike, latency or waiting time after the operation for requesting information until the information is transferred is needed. In using the regular Internet, an amount of used information is not so heavy, so that the latency is not so long as the user cannot stand it. However, when a ratio of an amount of information to a capacity of communication becomes larger, the latency can be prolonged to the extent that the user cannot stand it.

Besides, in the conventional information delivery system, the accounting process for the information service is carried out at which time the user makes an application for the information delivery. Therefore, in order to examine contents of information before purchasing it, the user has to make decision on whether or not to accept the charge after reading, checking, and confirming an outline of information, which is additionally made out by the provider. This means that the conventional system has a demerit of high-cost because the information provider needs to make out the outline of information separately. In providing the outline of information, character information is relatively easy to produce, however it is often difficult and also costly to produce graphic, video, and audio information.

### SUMMARY OF THE INVENTION

It is therefore an object of the present invention to provide an information delivery system wherein it is possible to deliver information smoothly without a pause and any delay.

According to a first aspect of the present invention, for achieving the above mentioned object, there is provided an information delivery system comprising an information delivery device which delivers information, an information storage and playback device which stores information transmitted from the information delivery device and reproduces the information if necessary, and an information communicating means which is connected to the information delivery device and the information storage and playback device, wherein:

the information storage and playback device includes means of storing each of a plurality of partial information of a plurality of delivery information beforehand, choosing one of the partial information from the plurality of the stored partial information and reproducing the chosen partial information, and giving notice of information that the one of the partial information has been chosen from the plurality of the delivery information to the information delivery device just as reproduction of the chosen partial information starts;

the information delivery device includes a means of transmitting remaining information of the partial information, which has been chosen to be reproduced and has been notified by the information storage and playback device, to the information storage and playback device just as reproduction of the partial information of the plurality of the delivery information finishes at the information storage and playback device; and

the information storage and playback device includes a means of reproducing the remaining information of the partial information transmitted from the information delivery device.

According to a second aspect of the present invention, there is provided an information delivery system comprising an information delivery device which delivers information, an information storage and playback device which stores information transmitted from the information delivery device and reproduces the information if necessary, and an information communicating means which is connected to the information delivery device and the information storage and playback device, wherein:

the information storage and playback device includes means of storing each of a plurality of partial information of a plurality of delivery information beforehand, choosing one of the partial information from the plurality of the stored partial information and reproducing the chosen partial information, and giving notice of information that the one of the partial information has been chosen from the plurality of the delivery information to the information delivery device just as reproduction of the chosen partial information starts;

the information delivery device includes a means of transmitting remaining information of the partial information which has been chosen to be reproduced at the information storage and playback device to the information storage and playback device while the information storage and playback device is reproducing the partial information; and

the information storage and playback device includes means of storing the remaining information of the partial information which has been chosen to be reproduced at the information storage and delivery device, and reproducing the stored remaining information of the partial information which has been chosen to be reproduced at the information storage and playback device just as reproduction of the partial information finishes.

According to a third aspect of the present invention, in the first or second aspect, in the information storage and playback device, the storing means is installed by:

connecting a storage medium, in which the partial information of the delivery information is set up by the information delivery device beforehand, to the information storage and playback device, or transmitting the partial information of the delivery information which is set up by the information delivery device beforehand from the information delivery device to the information storage and playback device through the information communicating means and storing the transmitted partial information of the delivery information in a storage medium by the information storage and playback device;

transmitting partial information of delivery information, which belongs to an information group chosen to be delivered by the information storage and playback device beforehand, from the information delivery device to the information storage and playback device through the information communicating means, and storing the transmitted partial information of the delivery information which belongs to the information group in a storage medium by the information storage and playback device;

transmitting partial information of delivery information, which belongs to one of information groups prioritized and sorted out according to a past record of a user of the information storage and playback device, from the information delivery device to the information storage and playback device through the information communicating means, and storing the transmitted partial information of the delivery information, which belongs to one of the information groups prioritized and sorted out according to the past record of the user of the information storage and playback device, in a storage medium by the information storage and playback device; or

transmitting partial information of delivery information, which belongs to one of information groups prioritized and sorted out according to past records of a plurality of users of the information storage and playback devices, from the information delivery device to the information storage and playback device through the information communicating means, and storing the transmitted partial information of the delivery information, which belongs to one of the information groups prioritized and sorted out according to the past records of the plurality of the users of the information storage and playback devices, in a storage medium by the information storage and playback device.

According to a fourth aspect of the present invention, in the first or second aspect, the partial information of the delivery information, which is transmitted form the information delivery device to the information storage and playback device through the information communicating means and is received and stored in the information storage and playback device, is renewed if necessary, and a means for storing the partial information of the delivery information in the information storage and playback device beforehand is installed by:

connecting a storage medium, in which the partial information of the delivery information is set up by the information delivery device beforehand, to the information storage and playback device, or transmitting the partial information of the delivery information which is set up by the information delivery device beforehand from the information delivery device to the information storage and playback device through the information communicating means, and storing the transmitted partial information of the delivery information in a storage medium by the information storage and playback device;

transmitting partial information of delivery information, which belongs to an information group chosen to be delivered by the information storage and playback device beforehand, from the information delivery device to the information storage and playback device through the information communicating means, and storing the transmitted partial information of the delivery information which belongs to the information group in a storage medium by the information storage and playback device;

transmitting partial information of delivery information, which belongs to one of information groups prioritized and sorted out according to a past record of a user of the information storage and playback device, from the information delivery device to the information storage and playback device through the information communicating means, and storing the transmitted partial information of the delivery information, which belongs to one of the information groups prioritized and sorted out according to the past record of the user of the information storage and playback device, in a storage medium by the information storage and playback device; or

transmitting partial information of delivery information, which belongs to one of information groups prioritized and sorted out according to past records of a plurality of users of the information storage and playback devices, from the information delivery device to the information storage and playback device through the information communicating means, and storing the transmitted partial information of the delivery information, which belongs to one of the information groups prioritized and sorted out according to the past records of the plurality of the users of the information storage and playback devices, in a storage medium by the information storage and playback device.

According to a fifth aspect of the present invention, in the first or second aspect, the information storage and playback device, which includes a plurality of storage mediums for storing information, stores the partial information of the delivery information in a primary storage medium, and stores the partial information of the delivery information and remaining information of the delivery information transmitted from the information delivery device in one of the other storage mediums different from the primary storage medium.

According to a sixth aspect of the present invention, in the first or second aspect, the information storage and playback device, which includes a plurality of storage mediums for storing information, stores the partial information of the delivery information in a primary storage medium, and stores the partial information of the delivery information and remaining information of the delivery information transmitted from the information delivery device in one of the other storage mediums different from the primary storage medium. Further, the information delivery system employs at least one selected from a removable disk, an optical disk, a phase change optical disk, and a tape medium as a storage medium different from the primal storage medium.

According to a seventh aspect of the present invention, in the first or second aspect, the information communicating means includes at least one selected from a communicating means by electric wave, a communicating means by electric wave going through a satellite, a communicating means by a public phone line, and a communicating means by the Internet.

According to an eighth aspect of the present invention, in the first or second aspect, the delivery information includes image information, moving picture information, or voice information.

According to a ninth aspect of the present invention, in the first or second aspect, the delivery information includes image information, moving picture information, or voice information. Further, the delivery information includes compressed data information.

According to a tenth aspect of the present invention, an information delivery system comprises an information delivery device which delivers information, an information storage and playback device which stores information transmitted from the information delivery device and reproduces the information if necessary, and an information communicating means which is connected to the information delivery device and the information storage and playback device, including steps of:

storing each of a plurality of partial information of a plurality of delivery information beforehand in the information storage and playback device;

choosing one of the partial information from the plurality of the stored partial information and reproducing the chosen partial information at the information storage and playback device;

giving notice of information that the one of the partial information has been chosen from the plurality of the delivery information to the information delivery device just as reproduction of the chosen partial information starts; and

transmitting remaining information of the partial information, which has been chosen to be reproduced and has been notified by the information storage and playback device to the information storage and playback device just as reproduction of the partial information of the plurality of the delivery information finishes at the information storage and playback device, and reproducing the remaining information of the partial information transmitted from the information delivery device.

According to an eleventh aspect of the present invention, an information delivery system comprises an information delivery device which delivers information, an information storage and playback device which stores information transmitted from the information delivery device and reproduces the information if necessary, and an information communicating means which is connected to the information delivery device and the information storage and playback device, including steps of:

storing each of a plurality of partial information of a plurality of delivery information beforehand in the information storage and playback device;

choosing one of the partial information from the plurality of the stored partial information and reproducing the chosen partial information at the information storage and playback device;

giving notice of information that the one of the partial information has been chosen from the plurality of the delivery information to the information delivery device just as reproduction of the chosen partial information starts;

transmitting remaining information of the partial information which has been chosen to be reproduced at the information storage and playback device to the information storage and playback device and storing the remaining information of the partial information which has been chosen to be reproduced at the information storage and delivery device while the information storage and playback device is reproducing the partial information; and

reproducing the stored remaining information of the partial information which has been chosen to be reproduced at the information storage and playback device just as reproduction of the partial information finishes.

According to a twelfth aspect of the present invention, in the tenth or eleventh aspect, the step of storing the partial information of the delivery information in the information storage and playback device beforehand includes a step of:

connecting a storage medium, in which the partial information of the delivery information is set up by the information delivery device beforehand, to the information storage and playback device, or transmitting the partial information of the delivery information which is set up by the information delivery device beforehand from the information delivery device to the information storage and playback device through the information communicating means and storing the transmitted part of the information of the delivery information in the information storage and playback device;

transmitting the partial information of the delivery information, which belongs to an information group chosen to be delivered by the information storage and playback device beforehand, from the information delivery device to the information storage and playback device through the information communicating means, and storing the transmitted partial information of the delivery information which belongs to the information group in the information storage and playback device;

transmitting partial information of delivery information, which belongs to one of information groups prioritized and sorted out according to a past record of a user of the information storage and playback device, from the information delivery device to the information storage and playback device through the information communicating means, and storing the transmitted partial information of the delivery information, which belongs to one of the information groups prioritized and sorted out according to the past record of the user of the information storage and playback device, in the information storage and playback device; or

transmitting partial information of delivery information, which belongs to one of information groups prioritized and sorted out according to past records of a plurality of users of the information storage and playback devices, from the information delivery device to the information storage and playback device through the information communicating means, and storing the transmitted partial information of the delivery information, which belongs to one of the information groups prioritized and sorted out according to the past records of the users of the information storage and playback devices, in the information storage and playback device.

According to a thirteenth aspect of the present invention, in the tenth or eleventh aspect, the partial information of the delivery information, which is transmitted form the information delivery device to the information storage and playback device through the information communicating means and is received and stored in the information storage and playback device, is renewed if necessary. Further, the step of storing the partial information of the delivery information in the information storage and playback device beforehand includes a step of:

connecting a storage medium, in which the partial information of the delivery information is set up by the information delivery device beforehand, to the information storage and playback device, or transmitting the partial information of the delivery information which is set up by the information delivery device beforehand from the information delivery device to the information storage and playback device through the information communicating means and storing the transmitted part of the information of the delivery information in the information storage and playback device;

transmitting the partial information of the delivery information, which belongs to an information group chosen to be delivered by the information storage and playback device beforehand, from the information delivery device to the information storage and playback device through the information communicating means, and storing the transmitted partial information of the delivery information which belongs to the information group in the information storage and playback device;

transmitting partial information of delivery information, which belongs to one of information groups prioritized and sorted out according to a past record of a user of the information storage and playback device, from the information delivery device to the information storage and playback device through the information communicating means, and storing the transmitted partial information of the delivery information, which belongs to one of the information groups prioritized and sorted out according to the past record of the user of the information storage and playback device, in the information storage and playback device; or

transmitting partial information of delivery information, which belongs to one of information groups prioritized and sorted out according to past records of a plurality of users of the information storage and playback devices, from the information delivery device to the information storage and playback device through the information communicating means, and storing the transmitted partial information of the delivery information, which belongs to one of the information groups prioritized and sorted out according to the past records of the users of the information storage and playback devices, in the information storage and playback device.

According to a fourteenth aspect of the present invention, employing the information delivery system in the first to ninth aspects, an information user making use of the information storage and playback device receives image, reflection or voice information from the information delivery device through the information communicating means, and an information provider, who delivers the image, reflection or voice information to the information user by employing the information delivery device, accounts for use of the image, reflection or voice information by the information user.

According to a fifteenth aspect of the present invention, in the fourteenth aspect, timing of the accounting is chosen from timing:

in parallel with a start of reproducing partial information of delivery information;

after a prescribed period of time from a start of reproducing the partial information of the delivery information; or

after reproducing a prescribed amount of the partial information of the delivery information from a start of reproducing the partial information of the delivery information.

According to a sixteenth aspect of the present invention, in the fourteenth aspect, timing of the accounting is chosen from timing:

in parallel with a start of reproducing remaining information of delivery information;

after a prescribed period of time from a start of reproducing the remaining information of the delivery information; or

after reproducing a prescribed amount of the remaining information of the delivery information from a start of reproducing the remaining information of the delivery information.

According to a seventeenth aspect of the present invention, in the fourteenth aspect, timing of the accounting is chosen from timing:

in parallel with a finish of reproducing remaining information of delivery information; or

after a prescribed time of a finish of reproducing the remaining information of the delivery information.

According to an eighteenth aspect of the present invention, in the fourteenth aspect, timing of the accounting is chosen from timing:

in parallel with a start of transmitting remaining information of delivery information;

after a prescribed time of a start of transmitting the remaining information of the delivery information; or

after transmitting a prescribed amount of the remaining information of the delivery information from a start of transmitting the remaining information of the delivery information.

In an information delivery system and a method of the present invention, a part of delivery information (partial information), which an information user hopes to obtain, has been already written in a recording medium embedded in an information storage and playback device beforehand at the moment when the information user operates the information storage and playback device. Therefore, it is possible to access the necessary partial information and start reproducing it immediately. The remaining delivery information needs to be read (downloaded) from an information delivery device through an information communicating means. It takes some time to finish downloading, and it also takes some time to reproduce all of the partial information which is stored in the recording medium. In the case where the volume of the data for the partial information is light, the reproduction finishes at once. On the other hand, in the case where the volume of the data for the partial information is heavy, it takes more time to reproduce it according to the volume. Therefore, by setting up the volume of data for the partial information to adequate volume, the remaining information is transmitted from the information delivery device to the information storage and playback device when the reproduction of the partial information has almost finished, so that it is possible to reproduce the remaining information in real time (claims 1 and 17). Even in the case where the volume of the remaining information is heavy, it is possible to reproduce the remaining information just as the remaining information is stored in the information storage and playback device (claims 2 and 18). Therefore, all of the information including the remaining information, which the information user hopes to obtain, can be delivered without a break as well as the information is delivered just as the information user operates the information storage and playback device.

The scope of the partial information, which is stored in the information storage and playback device, can be chosen diversely. The simplest method to set up the partial information is to store the partial information concerning all of the information which is held by an information provider in the information storage and playback device beforehand (claims 3 to 6 and 19 to 22). However, in the case where the provider holds volumes of information, it is difficult to store the partial information concerning all of the information in relation to memory capacity. Therefore, in the case where the volume of information is heavy, it is needed to narrow down the information which will be stored in the information storage and playback device.

There are several methods to narrow down the information.

As a first method, the information provider divides the information into some groups beforehand, and an information user of the information storage and playback device chooses a group(s) from the divided groups (claims 3 to 6 and 19 to 22). The information provider can divide the delivery information into proper size taking the memory capacity of user's magnetic storage and playback device into account. Besides, it is also possible to offer information in conformity with user's wishes by letting the user choose the information.

As a second method, the information provider chooses a group(s) to offer (claims 3 to 6 and 19 to 22). In this method to choose an information group(s), the provider can offer an information group(s) which is assumed to be needed by an information user(s). Besides, the information provider can add a certain volume of information of which the provider wishes to inform the information user(s) to the information assumed to be needed by the information user(s) at a constant rate.

As a third method, the delivery information is prioritized according to a past record of information used by an information user, and divided into delivery information and non-delivery information according to the order of the priority (claims 3 to 6 and 19 to 22). This method has the advantage of delivering information in which the user is interested by the priority. Besides, by prioritizing information related to the information which has been delivered in the same order by the set up of the information delivery system, it is possible to promote the user's convenience.

As a fourth method, the delivery information is prioritized according to past records of information used by plural information users, and divided into delivery information and non-delivery information according to the order of the priority (claims 3 to 6 and 19 to 22). By setting up a group(s) or scope of users whose past records are consulted on the provider's side, it is possible to promote the users' convenience.

By renewing information delivered to a user(s) according to need, it is possible to prevent scope of delivery information from eroding (claims 5, 6, 21 and 22).

The remaining information transmitted from the information delivery device to the information storage and playback device is reproduced after being stored in the information storage and playback device (claims 2 and 18). In the case where information transfer speed is late, latency arises during reproducing the partial information, and delivering information becomes discontinuous. However, this problem is avoidable by reproducing the remaining information after storing the remaining information in the information storage and playback device. That is, it becomes possible to deliver information continuously and to control reproducing speed so that an user(s) does not feel odd even though the reproduction is discontinuous.

By user's operation of the information storage and playback device, or automatically according to the condition of the information storage and playback device, a notice of an information delivery is given to the information delivery device or an information provider through the information communicating means as a record. By transmitting the record to the information delivery device or an information provider, it becomes possible to store data which will be basis for making out a delivery information group(s), and to change an information group(s) chosen by an information user(s).

By embedding a storage and playback device which employs a hard disk for a medium in the information storage and playback device, it is possible to increase an available volume of information to store.

By equipping the information storage and playback device with plural recording mediums, copying information chosen by a user(s) from a plurality of partial information stored in the information storage and playback device beforehand into one of the recording mediums, downloading remaining information, and uniting the remaining information to the partial information, it is possible to make out a disk including a series of information. Besides, by employing a removable medium, an optical disk such as a phase change optical disk, and a tape medium for the download, it becomes possible to keep the medium into which information is downloaded detaching from the information storage and playback device (claims 7 to 10).

By employing electric wave such as wave going through a satellite for an information communicating means, it becomes possible to supply much information from the information delivery devices in a wide range of area to the information storage and playback device. It is effective to employ a communicating means utilizing a telephone line, which is typified by the Internet, in transmitting wide range of information to the information storage and playback device (claims 11 and 12).

The object of the present invention is to provide an information delivery system which is capable of supplying volumes of information without a pause or making a user(s) feel odd. The information delivery device shows its favourable attribute most clearly when it is applied to the delivery of heavy volumes of information such as image information, moving picture information, music information, and voice information (claims 13 to 16). It is possible to transmit more information by compressing information (claims 15 and 16).

In the case where delivery information is pay information, timing of accounting can be chosen from timing below:

A. at the same time of a start of reproducing partial information;

B. after a prescribed period of time from a start of utilization of partial information;

C. after delivering a prescribed volume of information from a start of utilization of partial information;

D. at the same time of a start of delivering remaining information;

E. after a prescribed period of time from a start of delivering remaining information;

F. after delivering a prescribed volume of information from a star of delivering remaining information; and

G. after a finish of delivering remaining information (claims 23 to 27).

### BRIEF DESCRIPTION OF THE DRAWINGS

The objects and features of the present invention will become more apparent from the consideration of the following detailed description taken in conjunction with the accompanying drawings in which:

FIG. 1 is a diagram showing structure of an information delivery system according to the present invention;

FIG. 2 is a flowchart showing a flow of information in an information delivery system according to a first embodiment of the present invention;

FIG. 3 is a flowchart showing a flow of information in an information delivery system according to a second embodiment of the present invention;

FIG. 4 is a flowchart showing a flow of information in an information delivery system according to a third embodiment of the present invention;

FIG. 5 is a flowchart showing a flow of information in an information delivery system according to a fourth embodiment of the present invention;

FIG. 6 is a flowchart showing a flow of information in an information delivery system according to a fifth embodiment of the present invention;

FIG. 7 is a flowchart showing a flow of information in an information delivery system according to a sixth embodiment of the present invention;

FIG. 8 is a flowchart showing a flow of information in an information delivery system according to a seventh embodiment of the present invention;

FIG. 9 is a flowchart showing a flow of information in an information delivery system according to an eighth embodiment of the present invention; and

FIG. 10 is a flowchart showing a flow of information in an information delivery system according to a ninth embodiment of the present invention.

### DESCRIPTION OF THE PREFERRED EMBODIMENTS

Referring now to the drawings, embodiments of the present invention will be explained in detail.

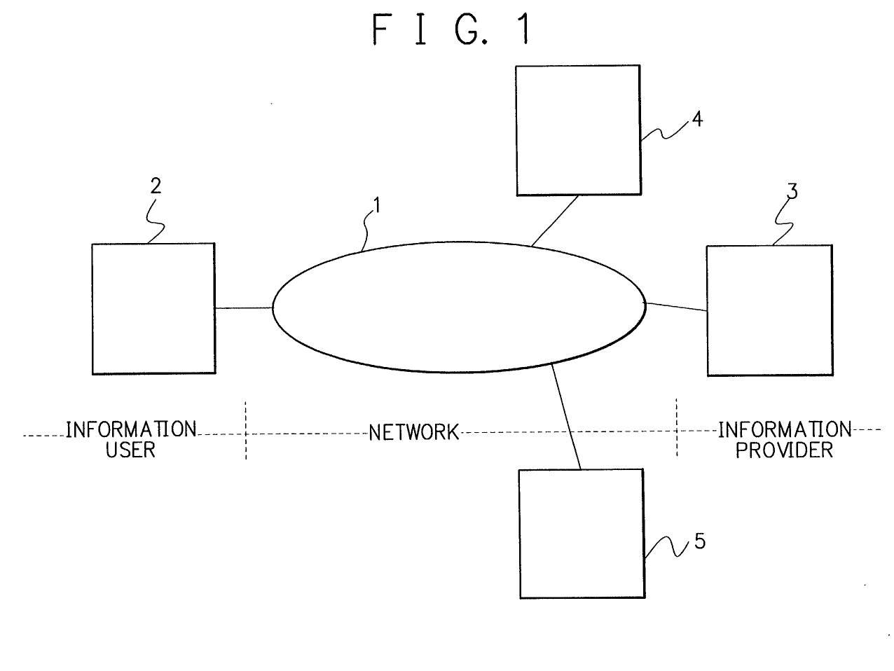

FIG. 1 is a diagram showing a structure of an information delivery system of the present invention, which basically comprises: an information storage and playback device 2 which stores data of intelligence home appliances such as a personal computer and a digital television, and multimedia information such as reflections, images, and voice and reproduces as required; an information communicating means 1 which sends information into the information storage and playback device 2; and an information delivery device 3 which delivers information to the information storage and playback device 2.

The information communicating means 1 can include a wired public communication network such as a phone line and a communicating means with a electric wave. Besides, if the information communicating means 1 includes a communicating means which goes through a satellite which are typified by a communication satellite, a broadcasting satellite, a weather satellites, and a military satellite, it become possible to communicate between the information delivery device 3 and the information storage and playback device 2 in a distant place. Utilizing broad casting such as communications satellite broadcasting and satellite broadcasting powerfully comes up for the telecommunication. Also it is possible to include a communicating means using such as the Internet.

Contents of delivered information may be image information, which is typified by moving picture information and voice information. To be concrete, it is possible to employ an information storage and playback system for moving picture information delivery service such as movies by treating moving picture information, and for voice information delivery service such as music by treating voice information, for example. In these cases, it is assumed that an on-demand type high-capacity digital audio/video file server and so forth are used as the information delivery device 3.

In carrying out the information delivery service, an accounting system 4 and a payment system 5 are connected to the information communicating means 1. The accounting system 4 charges an information user(s) for the information delivery service from the information delivery device 3 operated by an information provider to the information storage and playback device 2 owned by the information user, and the payment system 5 settles the accounting.

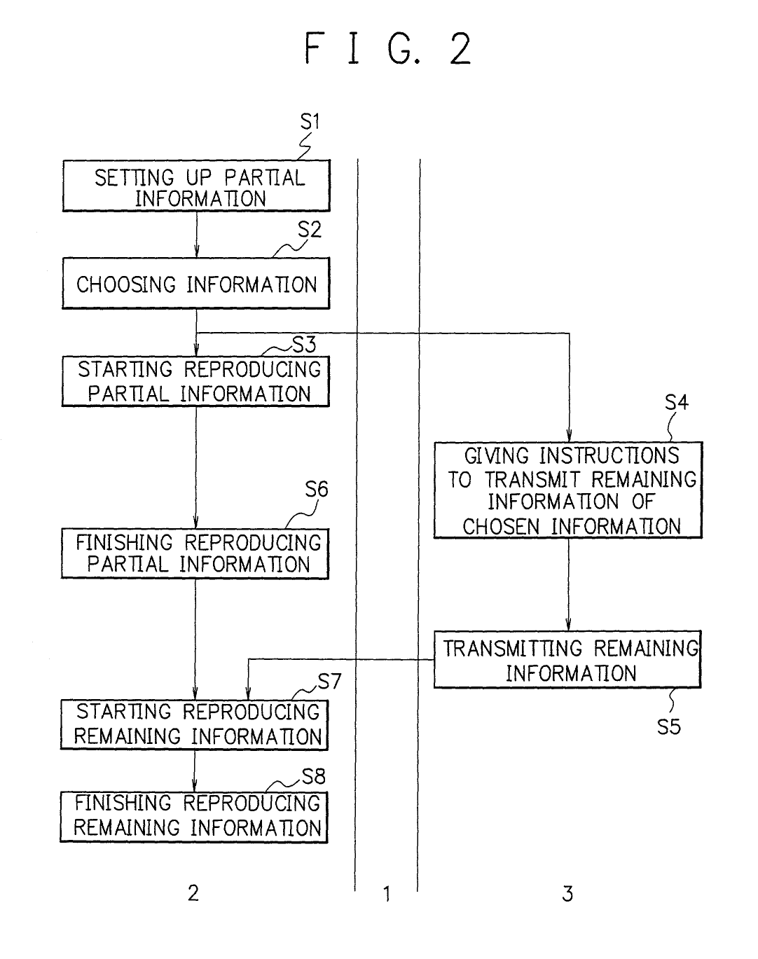

FIG. 2 is a flowchart showing a flow of information in information delivery service employing an information delivery system of a first embodiment of the present invention.

First, a plurality of partial information including partial information which an information user hopes to obtain have been already written in a storage medium embedded in the information storage and playback device 2 prior to user's operation of an information storage and playback system with the intent to get the information (S1). In the information storage and playback device 2 of this embodiment, the plurality of the partial information may as well be newly installed (downloaded) from the information delivery device 3 through the information communicating means 1, or installed (recorded or downloaded) into a piece of portable recording equipment or a portable recording medium beforehand, which is connected to the information storage and playback device 2.

In the case where the information delivery service includes moving picture information delivery service such as movies and music delivery service and so forth, the plurality of the partial information may be, for example, a menu including titles of movies, an initial scene which appears for several minutes when clicking one of the movies' titles, a menu including titles of music, and the high point of chosen music.

Second, the information user operates the information delivery device 3 from the information storage and playback device 2 through the information communicating means 1. Thereby a piece of partial information which the information user hopes to obtain is chosen from among the plurality of the partial information (S2). After that, reproduction of the chosen partial information starts on the information storage and playback device 2 (S3). At the same time, information that the partial information has been chosen is sent from the information storage and playback device 2 to the information delivery device 3 through the information communicating means 1. In response to the information that the partial information has been chosen, the information delivery device 3 issues instructions to transfer “rest of information” of the chosen information to the information storage and playback device 2 (S4). Then the “remaining information” is transmitted to the information storage and playback device 2 used by the information user (S5). The remaining information is compressed when transmitted to the information storage and playback device 2. Then, the remaining information compressed and transmitted from the information delivery device 3 is uncompressed and reproduced in real time at the information storage and playback device 2 as soon as reproduction of the partial information has finished (S7, S8).

A medium for mass storage such as a hard disk is an appropriate example as a recording medium for storing the partial information.

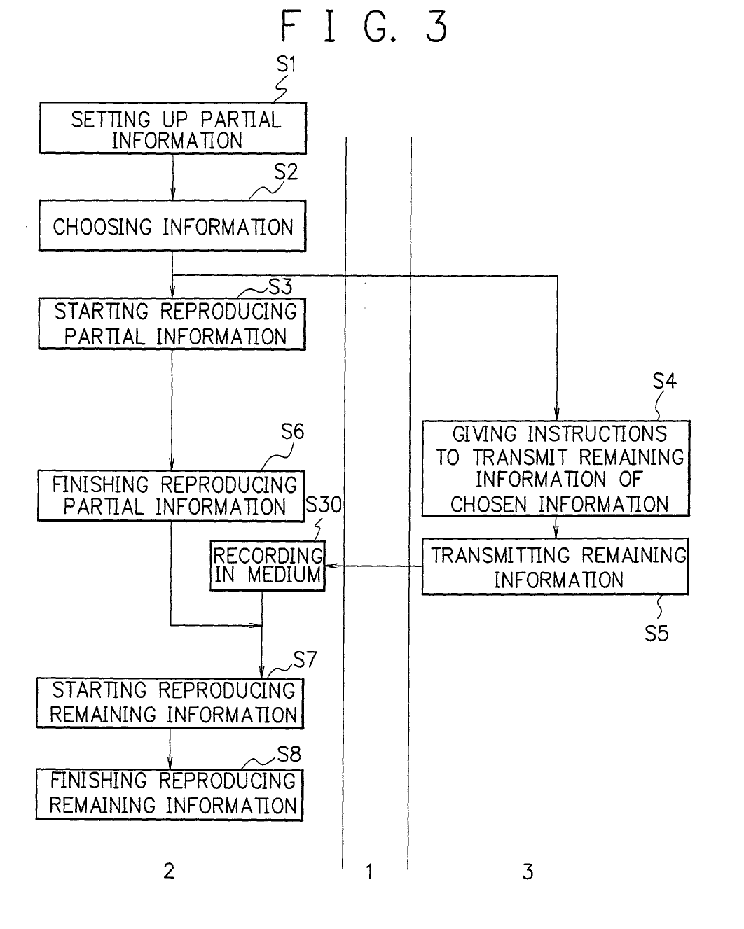

FIG. 3 is a flowchart showing a flow of information in information delivery service employing an information delivery system of a second embodiment of the present invention.

A plurality of partial information is stored in an information storage and playback device 2 beforehand (S1). The method for installing the partial information is the same as the first embodiment in FIG. 2. By operating the information delivery device 3 through the information storage and playback device 2, a piece of partial information which the user hopes to obtain is chosen from among the plurality of the partial information (S2). Then reproduction of the chosen partial information starts (S3). At the same time, a piece of information that the partial information has been chosen is sent from the information storage and playback device 2 to the information delivery device 3 through the information communicating means 1. By receiving the information (that the partial information has been chosen) by the information delivery device 3, instructions to transfer the rest of the chosen information to the information storage and playback device 2 is applied (S4). Then the remaining information is transmitted to the information storage and playback device 2 used by the information user (S5). The remaining information is saved in a medium embedded in the information storage and playback device 2 (S30). In response to a finish of reproducing the chosen partial information (S6), the remaining information is reproduced at the information storage and playback device 2. The remaining information is compressed and transferred to the information storage and playback device 2, and uncompressed and reproduced at the information storage and playback device 2 (S7, S8).

A medium for mass storage such as a hard disk is an appropriate example as a recording medium for storing the remaining information along with the partial information.

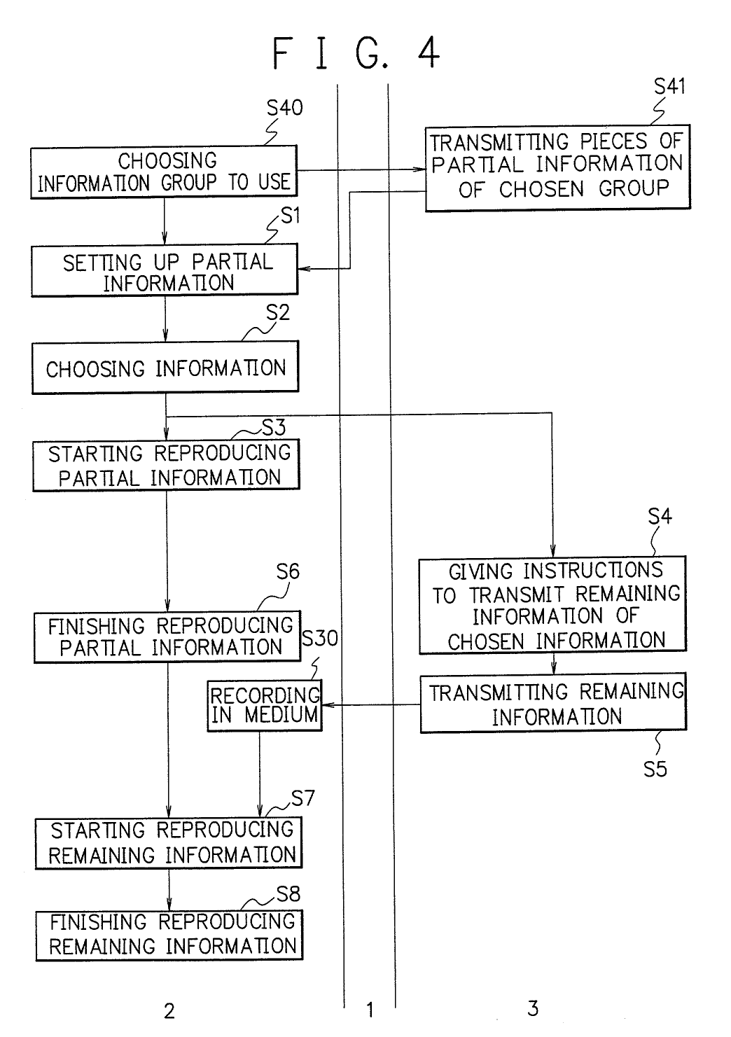

FIG. 4 is a flowchart showing a flow of information in information delivery service employing an information delivery system of a third embodiment of the present invention.

This embodiment differs in below from the second embodiment illustrated in FIG. 3 in setting up partial information which is to be installed in an information storage and playback device 2 beforehand. An information user, who uses the information storage and playback device 2, chooses an information group (which the user hopes to obtain) and sends information (that the user has chosen the information group) to an information delivery device 3 (S40). The information delivery device 3 sends pieces of the partial information of the chosen information group to the information storage and playback device 2 (S41). Then the information storage and playback device 2 installs and sets up the received pieces of the partial information of the chosen information group (S1). From these steps onward, procedures are the same as that of the second embodiment as shown in FIG. 3.

In the case of reflection delivery service, the pieces of the partial information of the information group are, for example, a category of movies' program such as a western film and an actuality film, and are the high point of the initial scene. On the other hand, in the case of music delivery service, the partial information of the information group is, for example, a category of music such as popular music, and the high point of music.

In Step 40, an information communicating means, which is used when the information that the user has chosen the information group is transmitted from the user to an information provider, may as well be a means other than the means used for transmitting the remaining information to the information storage and playback device 2 (S5). For example, by applying a means such as a radio portable terminal which is divided from the information storage and playback device 2, the user may transmit the chosen information group to the information provider through the information delivery device 3.

Besides, in the information storage and playback device 2, the step of installing the pieces of the partial information from the information delivery device 3 (S1) may not be applied through an information communicating means 1. To be concrete, pieces of partial information may be transferred being stored in, for example, a magnetic memory or a removable disk, and installed by connecting the storage device to the information storage and playback device 2. Further, it is possible to reinstall the pieces of the partial information stored in the information storage and playback device 2 at pleasure.

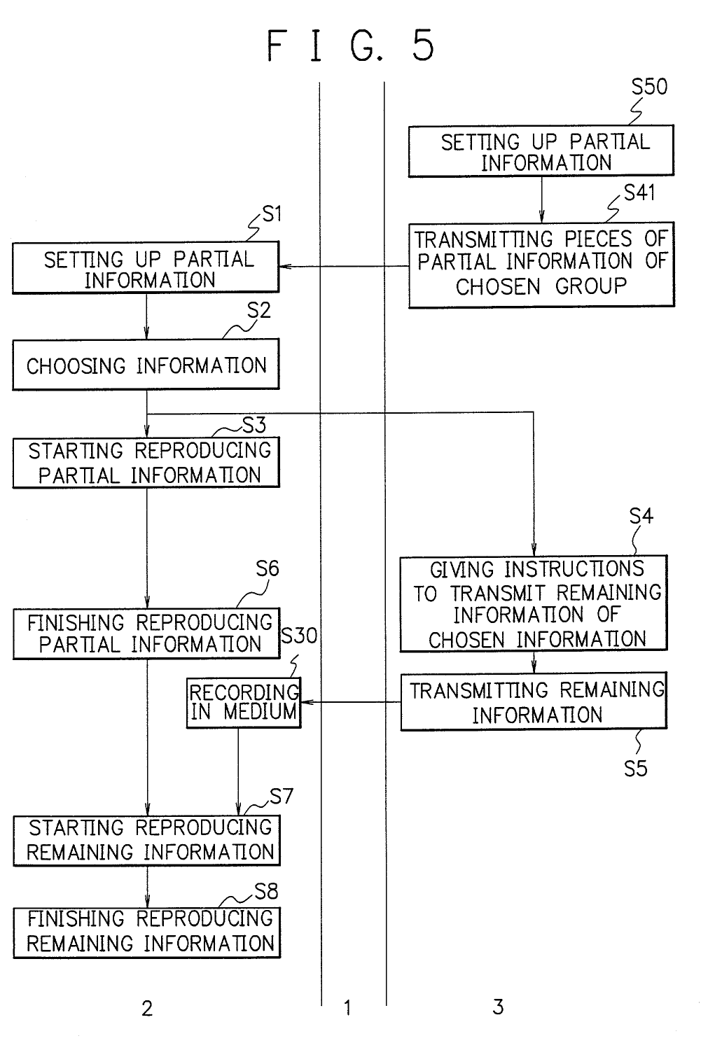

FIG. 5 is a flowchart showing a flow of information in information delivery service employing an information delivery system of a fourth embodiment of the present invention.

In fourth embodiment differing from the third embodiment, a choice of information group of partial information which is to be installed in an information storage and playback device 2 beforehand is not determined by an information user but by an information delivery device 3 on information provider's side (S50). Then the pieces of the partial information belonging to the chosen group are transmitted to the information storage and playback device 2 (S41). From setting up the partial information in the information storage and playback device 2 (Si) to a completion of reproducing the remaining information, the procedures are the same that of the second and third embodiments as shown in FIGS. 3 and 4, respectively.

The step of installing the piece of the partial information is same as the third embodiment.

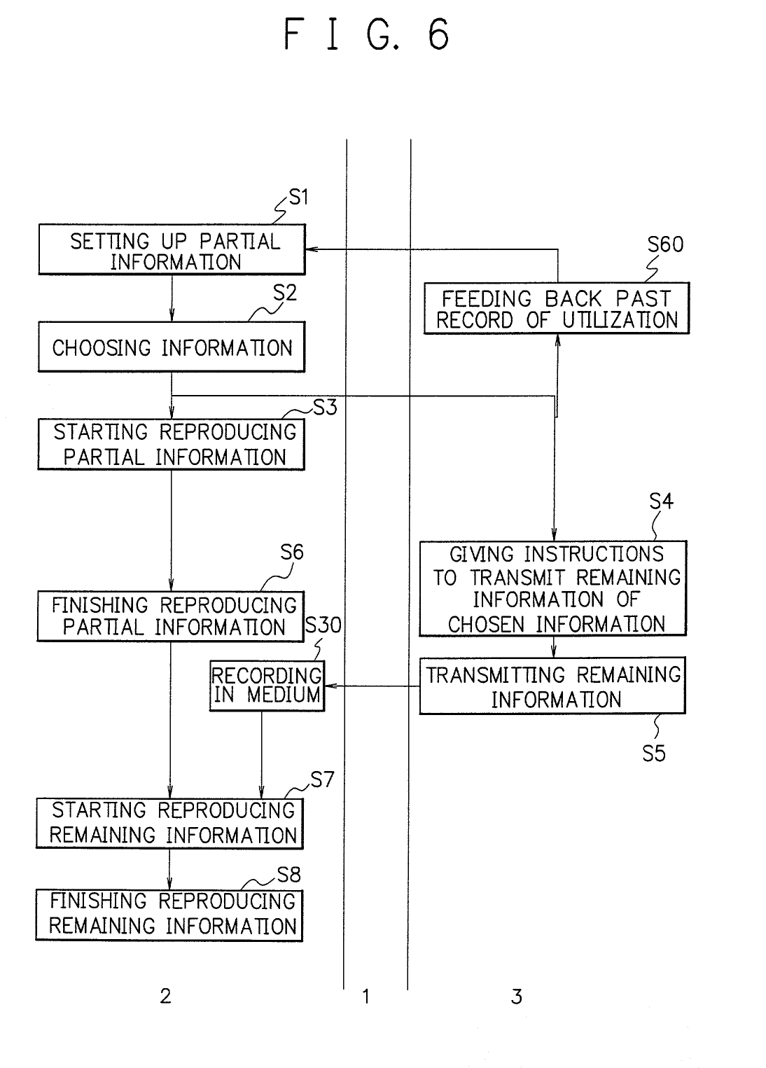

FIG. 6 is a flowchart showing a flow of information in information delivery service employing an information delivery system of a fifth embodiment of the present invention.

In this embodiment differing from the fourth embodiment in FIG. 5, pieces of partial information belonging to an information group (which are to be transmitted from an information provider using an information delivery device 3 and stored in an information storage and playback device 2 on an information user's side beforehand) is renewed by feeding back a past record of information utilization by a user of the information storage and playback device 2 through an information communicating means 1 (S60). From setting up the partial information belonging to the information group in the information storage and playback device 2 (S1) to a completion of reproducing the remaining information (S8), the procedures are the same as that of the second to fourth embodiments as shown in FIGS. 3 to 5 respectively.

A method of renewing the pieces of the partial information belonging to the information group at an information delivery device 3 (S60) is, for example, a way of involving information which is used by the user at frequent interval in the pieces of the partial information along with its related information, and eliminating partial information which is not used by the user at frequent interval. It is possible to renew the pieces of the partial information as often as the user utilizes information, and to renew after a prescribed period of time or after using information at prescribed number of times taking the past record of the user during the period into account.

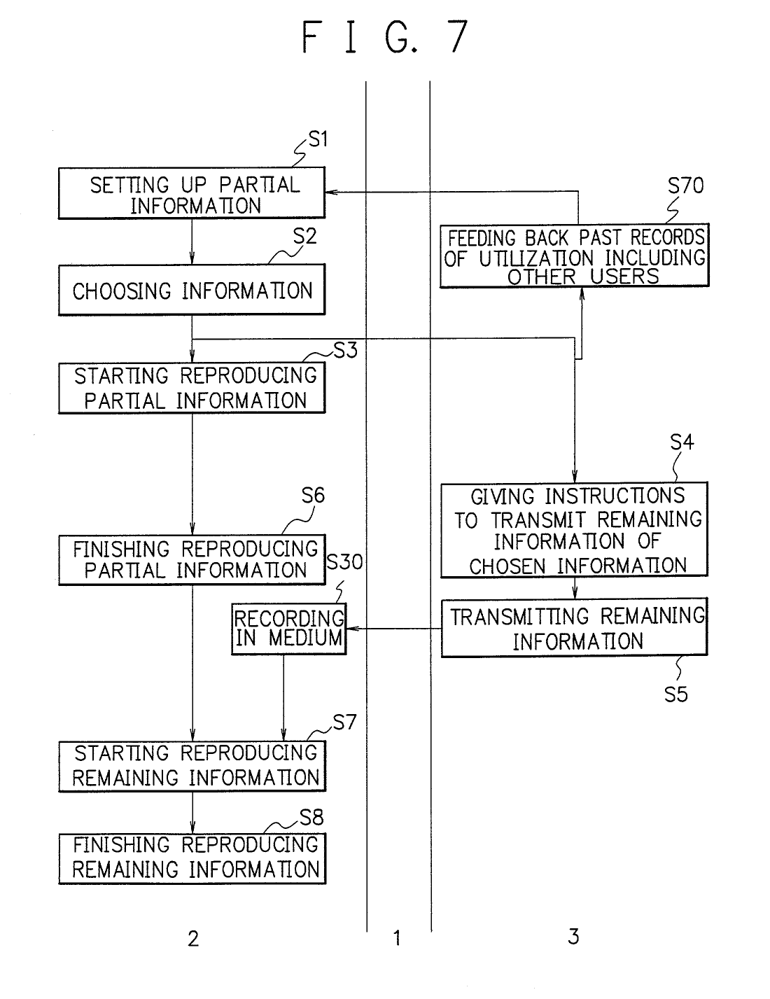

FIG. 7 is a flowchart showing a flow of information in information delivery service employing an information delivery system of a sixth embodiment of the present invention.

In this embodiment differing from the fifth embodiment in FIG. 6, pieces of partial information belonging to an information group, which are to be transmitted from an information provider using an information delivery device 2 and stored in an information storage and playback device 2 on an information user's side beforehand, is renewed by feeding back past records of information utilization by plural users of information storage and playback devices 2 through the information communicating means 1 (S70). From setting up the partial information belonging to the information group in the information storage and playback device 2 (S1) to a completion of reproducing the remaining information (S8), the procedures are the same as that of the second to fifth embodiments as shown in FIGS. 3 to 6 respectively.

A method of renewing the pieces of the partial information belonging to the information group (S60) is the same as that of the fifth embodiment as shown in FIG. 6.

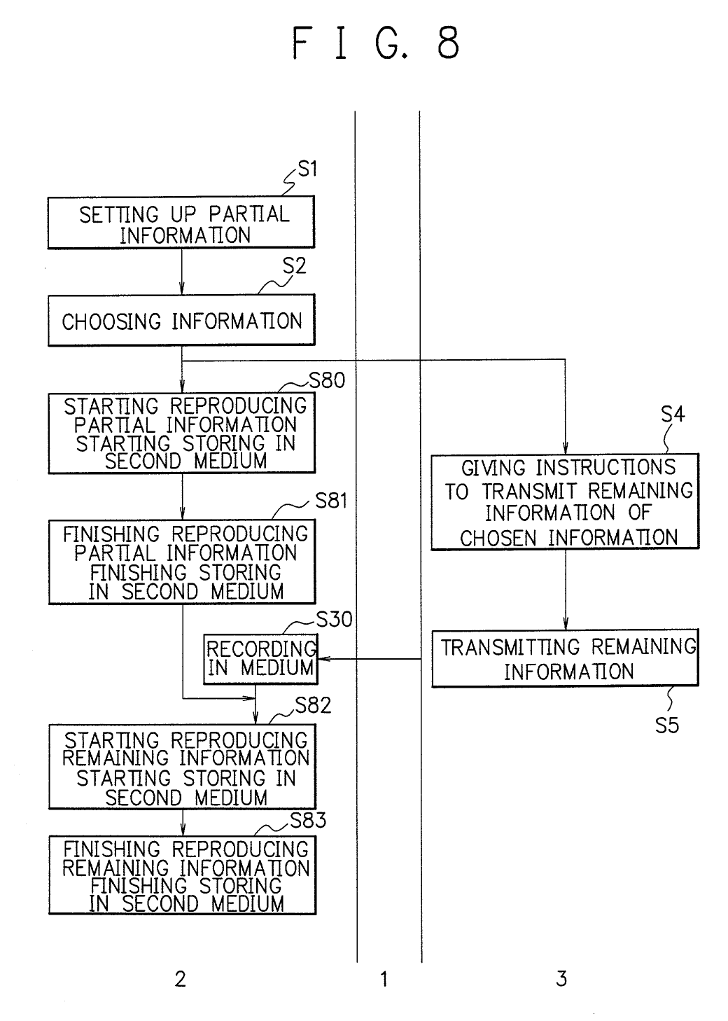

FIG. 8 is a flowchart showing a flow of information in information delivery service employing an information delivery system of a seventh embodiment of the present invention.

Partial information is stored in an information storage and playback device 2 beforehand (S1). The method for installing the partial information is the same as above-mentioned. An information which an user hopes to obtain is chosen by operating the information delivery device 3 (S2). The chosen partial information is reproduced, and the reproduced information is stored in a second recording medium equipped in the information storage and playback device 2 (S80).

The second recording medium may be one of the two sheets of the mediums. However, the first recording medium is generally a medium, a region of a medium(s), or pieces of mediums, which is for storing the pieces of partial information beforehand or storing the remaining information sent from the information delivery device 3. Therefore, the second recording medium is a medium, or a region of a medium(s), or pieces of mediums, which is distinguished from the first recording medium.

On a start of reproducing the chosen partial information, information that the partial information has been chosen is transmitted from the information storage and playback device 2 to the information delivery device 3 through the information communicating means 1. By receiving the information (that the partial information has been chosen), instructions to transmit the rest of the chosen information to the information storage and playback device 2 is issued (S4). Thereby, the remaining information is transmitted from the information delivery device 3 to the information storage and playback device 2 (S5). At the information storage and playback device 2, the transmitted remaining information is stored in a first recording medium embedded in the information storage and playback device 2 (S6). In response to the completion of reproducing the partial information and storing it in the second recording medium (S81), the remaining information is reproduced at the information storage and playback device 2 and stored in the second recording medium (S82, S83).

By this means, all of the information chosen by the user is stored in the second recording medium. A recording medium such as an optical disk, which is typified by a phase change optical disk, an removable magnetic disk, an optical tape medium, and a magnetic tape medium, powerfully comes up for the second recording medium.

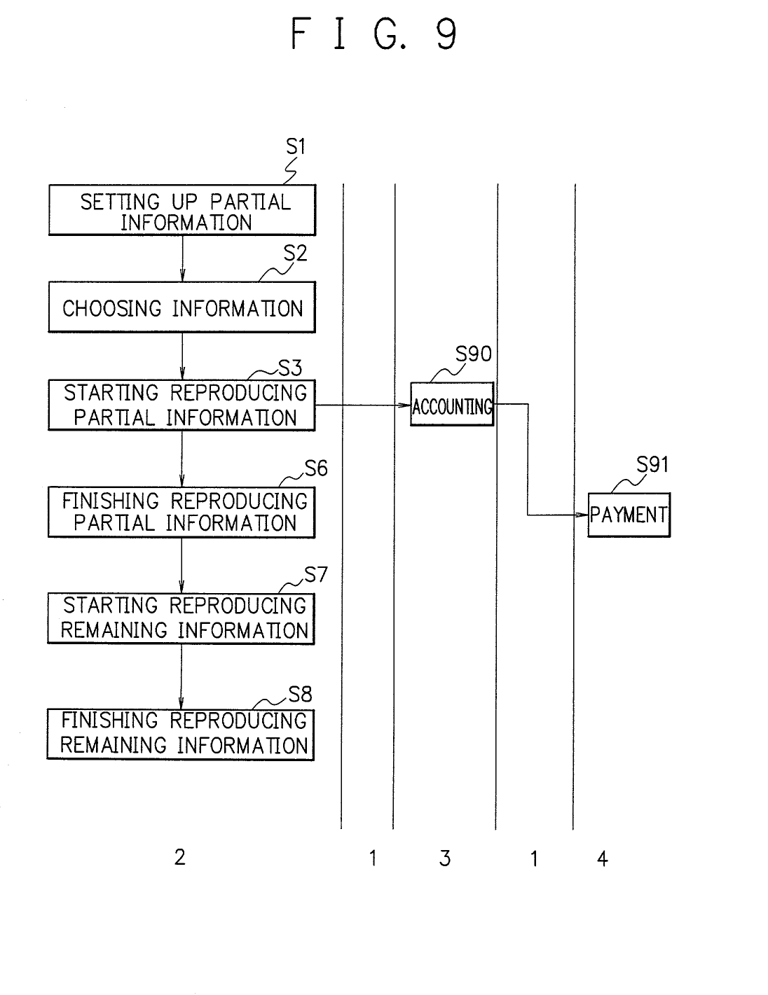

FIG. 9 is a flowchart showing a flow of information including an accounting system and a payment system in information delivery service employing an information delivery system of an eighth embodiment of the present invention.

In this embodiment shown in FIG. 9, the accounting is carried out (S90) when information that a piece of partial information is used by an information user is sent to an accounting system 4 through an information communicating means 1 just as the partial information is reproduced at an information storage and playback device 2 on the information user's side (S3). The accounting information is sent to a payment system 5 wherein payment from the user is settled (S91).

The timing of informing the accounting system 4 of the accounting information from the information storage and playback device 2 on the user's side may be the above-described timing on starting the reproduction of the partial information. Also the timing may be selected from a variety of conceivable steps in addition to the above-described timing. Besides, there is another case that a time lag or gap is set up between the timing of informing the accounting system 4 of the accounting information and the accounting is actually carried out to the user.

That is, the timing of giving notice of the accounting information is selected from the following eight ways: when the reproduction of the partial information is started (S3); after a prescribed period of time from the start of the reproduction of the partial information; when the reproduction of the partial information is finished (S6); after a prescribed period of time from the finish of the reproduction of the partial information; when the reproduction of remaining information is started (S7); after a prescribed period of time from the start of reproducing the remaining information; when the reproduction of the remaining information is finished (S8); and after a prescribed period of time from the finish of reproducing the remaining information. The timing of actual accounting is selected from the following two ways: when the accounting system 4 is informed of the accounting information; and after a prescribed period of time from giving notice of the accounting information.

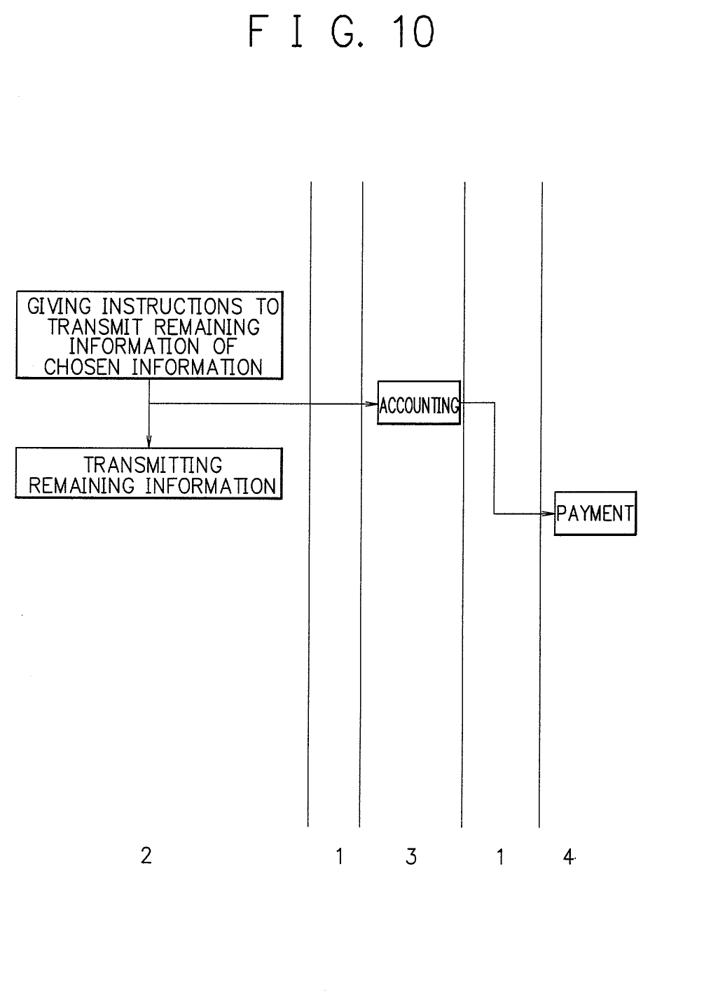

FIG. 10 is a flow chart showing a flow of information including an accounting system and a payment system in information delivery service employing an information delivery system of a ninth embodiment of the present invention.

FIG. 10 shows a case where accounting information is transmitted from a side of an information provider. In this embodiment, in the information delivery device 3, the accounting information is transmitted to an accounting system 4 and the accounting is carried out when the remaining information is transmitted to an information storage and playback device 2. Besides, the accounting information is transmitted to a payment system 5 and the payment is carried out.

The timing of giving notice of the accounting information from the information delivery device 3 to the accounting system 4 is selected from the following four ways: when the remaining information is transmitted to the information storage and playback device 2; after a certain amount of the remaining information is reproduced from the start of the transmission; after a prescribed period of time from the start of the transmission; and after the transmission is finished.

As set forth hereinabove, in the information delivery system including the information delivery device 3, the information communicating means 1, and the information storage and playback device 2, it will become possible to provide information smoothly without any delay. Besides, it will become possible for a user to grasp partial information without the preparation of the outline of contents in information service by an information provider.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. An information delivery system, comprising an information delivery device which delivers information, an information storage and playback device which stores information transmitted from the information delivery device and reproduces the information if necessary, and an information communicating means which is connected to the information delivery device and the information storage and playback device, wherein:
the information storage and playback device includes means of storing each of a plurality of partial information of a plurality of delivery information beforehand, choosing one of the partial information from the plurality of the stored partial information and reproducing the chosen partial information, and giving notice of information that the one of the partial information has been chosen from the plurality of the delivery information to the information delivery device just as reproduction of the chosen partial information starts;
the information delivery device includes a means of transmitting remaining information of the partial information, which has been chosen to be reproduced and has been notified by the information storage and playback device, to the information storage and playback device just as reproduction of the partial information of the plurality of the delivery information finishes at the information storage and playback device; and
the information storage and playback device includes a means of reproducing the remaining information of the partial information transmitted from the information delivery device.

2. An information delivery system, comprising an information delivery device which delivers information, an information storage and playback device which stores information transmitted from the information delivery device and reproduces the information if necessary, and an information communicating means which is connected to the information delivery device and the information storage and playback device, wherein:
the information storage and playback device includes means of storing each of a plurality of partial information of a plurality of delivery information beforehand, choosing one of the partial information from the plurality of the stored partial information and reproducing the chosen partial information, and giving notice of information that the one of the partial information has been chosen from the plurality of the delivery information to the information delivery device just as reproduction of the chosen partial information starts;
the information delivery device includes a means of transmitting remaining information of the partial information which has been chosen to be reproduced at the information storage and playback device to the information storage and playback device while the information storage and playback device is reproducing the partial information; and
the information storage and playback device includes means of storing the remaining information of the partial information which has been chosen to be reproduced at the information storage and delivery device, and reproducing the stored remaining information of the partial information which has been chosen to be reproduced at the information storage and playback device just as reproduction of the partial information finishes.

3. The information delivery system as claimed in claim 1, wherein a means for storing the partial information of the delivery information in the information storage and playback device beforehand is installed by:
connecting a storage medium, in which the partial information of the delivery information is set up by the information delivery device beforehand, to the information storage and playback device, or transmitting the partial information of the delivery information which is set up by the information delivery device beforehand from the information delivery device to the information storage and playback device through the information communicating means and storing the transmitted partial information of the delivery information in a storage medium by the information storage and playback device;
transmitting partial information of delivery information, which belongs to an information group chosen to be delivered by the information storage and playback device beforehand, from the information delivery device to the information storage and playback device through the information communicating means, and storing the transmitted partial information of the delivery information which belongs to the information group in a storage medium by the information storage and playback device;
transmitting partial information of delivery information, which belongs to one of information groups prioritized and sorted out according to a past record of a user of the information storage and playback device, from the information delivery device to the information storage and playback device through the information communicating means, and storing the transmitted partial information of the delivery information, which belongs to one of the information groups prioritized and sorted out according to the past record of the user of the information storage and playback device, in a storage medium by the information storage and playback device; or
transmitting partial information of delivery information, which belongs to one of information groups prioritized and sorted out according to past records of a plurality of users of the information storage and playback devices, from the information delivery device to the information storage and playback device through the information communicating means, and storing the transmitted partial information of the delivery information, which belongs to one of the information groups prioritized and sorted out according to the past records of the plurality of the users of the information storage and playback devices, in a storage medium by the information storage and playback device.

4. The information delivery system as claimed in claim 2, wherein a means for storing the partial information of the delivery information in the information storage and playback device beforehand is installed by:
connecting a storage medium, in which the partial information of the delivery information is set up by the information delivery device beforehand, to the information storage and playback device, or transmitting the partial information of the delivery information which is set up by the information delivery device beforehand from the information delivery device to the information storage and playback device through the information communicating means and storing the transmitted partial information of the delivery information in a storage medium by the information storage and playback device;
transmitting partial information of delivery information, which belongs to an information group chosen to be delivered by the information storage and playback device beforehand, from the information delivery device to the information storage and playback device through the information communicating means, and storing the transmitted partial information of the delivery information which belongs to the information group in a storage medium by the information storage and playback device;
transmitting partial information of delivery information, which belongs to one of information groups prioritized and sorted out according to a past record of a user of the information storage and playback device, from the information delivery device to the information storage and playback device through the information communicating means, and storing the transmitted partial information of the delivery information, which belongs to one of the information groups prioritized and sorted out according to the past record of the user of the information storage and playback device, in a storage medium by the information storage and playback device; or
transmitting partial information of delivery information, which belongs to one of information groups prioritized and sorted out according to past records of a plurality of users of the information storage and playback devices, from the information delivery device to the information storage and playback device through the information communicating means, and storing the transmitted partial information of the delivery information, which belongs to one of the information groups prioritized and sorted out according to the past records of the plurality of the users of the information storage and playback devices, in a storage medium by the information storage and playback device.

5. The information delivery system as claimed in claim 1, wherein:
the partial information of the delivery information, which is transmitted form the information delivery device to the information storage and playback device through the information communicating means and is received and stored in the information storage and playback device, is renewed if necessary; and
a means for storing the partial information of the delivery information in the information storage and playback device beforehand is installed by:
connecting a storage medium, in which the partial information of the delivery information is set up by the information delivery device beforehand, to the information storage and playback device, or transmitting the partial information of the delivery information which is set up by the information delivery device beforehand from the information delivery device to the information storage and playback device through the information communicating means, and storing the transmitted partial information of the delivery information in a storage medium by the information storage and playback device;
transmitting partial information of delivery information, which belongs to an information group chosen to be delivered by the information storage and playback device beforehand, from the information delivery device to the information storage and playback device through the information communicating means, and storing the transmitted partial information of the delivery information which belongs to the information group in a storage medium by the information storage and playback device;
transmitting partial information of delivery information, which belongs to one of information groups prioritized and sorted out according to a past record of a user of the information storage and playback device, from the information delivery device to the information storage and playback device through the information communicating means, and storing the transmitted partial information of the delivery information, which belongs to one of the information groups prioritized and sorted out according to the past record of the user of the information storage and playback device, in a storage medium by the information storage and playback device; or
transmitting partial information of delivery information, which belongs to one of information groups prioritized and sorted out according to past records of a plurality of users of the information storage and playback devices, from the information delivery device to the information storage and playback device through the information communicating means, and storing the transmitted partial information of the delivery information, which belongs to one of the information groups prioritized and sorted out according to the past records of the plurality of the users of the information storage and playback devices, in a storage medium by the information storage and playback device.

6. The information delivery system as claimed in claim 2, wherein:
the partial information of the delivery information, which is transmitted form the information delivery device to the information storage and playback device through the information communicating means and is received and stored in the information storage and playback device, is renewed if necessary; and
a means for storing the partial information of the delivery information in the information storage and playback device beforehand is installed by:
connecting a storage medium, in which the partial information of the delivery information is set up by the information delivery device beforehand, to the information storage and playback device, or transmitting the partial information of the delivery information which is set up by the information delivery device beforehand from the information delivery device to the information storage and playback device through the information communicating means, and storing the transmitted partial information of the delivery information in a storage medium by the information storage and playback device;
transmitting partial information of delivery information, which belongs to an information group chosen to be delivered by the information storage and playback device beforehand, from the information delivery device to the information storage and playback device through the information communicating means, and storing the transmitted partial information of the delivery information which belongs to the information group in a storage medium by the information storage and playback device;
transmitting partial information of delivery information, which belongs to one of information groups prioritized and sorted out according to a past record of a user of the information storage and playback device, from the information delivery device to the information storage and playback device through the information communicating means, and storing the transmitted partial information of the delivery information, which belongs to one of the information groups prioritized and sorted out according to the past record of the user of the information storage and playback device, in a storage medium by the information storage and playback device; or
transmitting partial information of delivery information, which belongs to one of information groups prioritized and sorted out according to past records of a plurality of users of the information storage and playback devices, from the information delivery device to the information storage and playback device through the information communicating means, and storing the transmitted partial information of the delivery information, which belongs to one of the information groups prioritized and sorted out according to the past records of the plurality of the users of the information storage and playback devices, in a storage medium by the information storage and playback device.

7. The information delivery device as claimed in claim 1, wherein the information storage and playback device, which includes a plurality of storage mediums for storing information, stores the partial information of the delivery information in a primary storage medium, and stores the partial information of the delivery information and remaining information of the delivery information transmitted from the information delivery device in one of the other storage mediums different from the primary storage medium.

8. The information delivery device as claimed in claim 2, wherein the information storage and playback device, which includes a plurality of storage mediums for storing information, stores the partial information of the delivery information in a primary storage medium, and stores the partial information of the delivery information and remaining information of the delivery information transmitted from the information delivery device in one of the other storage mediums different from the primary storage medium.

9. The information delivery device as claimed in claim 1, wherein:
the information storage and playback device, which includes a plurality of storage mediums for storing information, stores the partial information of the delivery information in a primary storage medium, and stores the partial information of the delivery information and remaining information of the delivery information transmitted from the information delivery device in one of the other storage mediums different from the primary storage medium; and
the information delivery system employs at least one selected from a removable disk, an optical disk, a phase change optical disk, and a tape medium as a storage medium different from the primal storage medium.

10. The information delivery device as claimed in claim 2, wherein:
the information storage and playback device, which includes a plurality of storage mediums for storing information, stores the partial information of the delivery information in a primary storage medium, and stores the partial information of the delivery information and remaining information of the delivery information transmitted from the information delivery device in one of the other storage mediums different from the primary storage medium; and
the information delivery system employs at least one selected from a removable disk, an optical disk, a phase change optical disk, and a tape medium as a storage medium different from the primal storage medium.

11. The information delivery system as claimed in claim 1, wherein the information communicating means includes at least one selected from a communicating means by electric wave, a communicating means by electric wave going through a satellite, a communicating means by a public phone line, and a communicating means by the Internet.

12. The information delivery system as claimed in claim 2, wherein the information communicating means includes at least one selected from a communicating means by electric wave, a communicating means by electric wave going through a satellite, a communicating means by a public phone line, and a communicating means by the Internet.

13. The information delivery system as claimed in claim 1, wherein the delivery information includes image information, moving picture information, or voice information.

14. The information delivery system as claimed in claim 2, wherein the delivery information includes image information, moving picture information, or voice information.

15. The information delivery system as claimed in claim 1, wherein:
the delivery information includes image information, moving picture information, or voice information; and
the delivery information includes compressed data information.

16. The information delivery system as claimed in claim 2, wherein:
the delivery information includes image information, moving picture information, or voice information; and
the delivery information includes compressed data information.

17. A method for delivering information, in an information delivery system comprising an information delivery device which delivers information, an information storage and playback device which stores information transmitted from the information delivery device and reproduces the information if necessary, and an information communicating means which is connected to the information delivery device and the information storage and playback device, including steps of:
storing each of a plurality of partial information of a plurality of delivery information beforehand in the information storage and playback device;
choosing one of the partial information from the plurality of the stored partial information and reproducing the chosen partial information at the information storage and playback device;
giving notice of information that the one of the partial information has been chosen from the plurality of the delivery information to the information delivery device just as reproduction of the chosen partial information starts; and
transmitting remaining information of the partial information, which has been chosen to be reproduced and has been notified by the information storage and playback device to the information storage and playback device just as reproduction of the partial information of the plurality of the delivery information finishes at the information storage and playback device, and reproducing the remaining information of the partial information transmitted from the information delivery device.

18. A method for delivering information, in an information delivery system comprising an information delivery device which delivers information, an information storage and playback device which stores information transmitted from the information delivery device and reproduces the information if necessary, and an information communicating means which is connected to the information delivery device and the information storage and playback device, including steps of:
storing each of a plurality of partial information of a plurality of delivery information beforehand in the information storage and playback device;
choosing one of the partial information from the plurality of the stored partial information and reproducing the chosen partial information at the information storage and playback device;
giving notice of information that the one of the partial information has been chosen from the plurality of the delivery information to the information delivery device just as reproduction of the chosen partial information starts;
transmitting remaining information of the partial information which has been chosen to be reproduced at the information storage and playback device to the information storage and playback device and storing the remaining information of the partial information which has been chosen to be reproduced at the information storage and delivery device while the information storage and playback device is reproducing the partial information; and
reproducing the stored remaining information of the partial information which has been chosen to be reproduced at the information storage and playback device just as reproduction of the partial information finishes.

19. The method for delivering information as claimed in claim 17, wherein the step of storing the partial information of the delivery information in the information storage and playback device beforehand includes a step of:
connecting a storage medium, in which the partial information of the delivery information is set up by the information delivery device beforehand, to the information storage and playback device, or transmitting the partial information of the delivery information which is set up by the information delivery device beforehand from the information delivery device to the information storage and playback device through the information communicating means and storing the transmitted part of the information of the delivery information in the information storage and playback device;
transmitting the partial information of the delivery information, which belongs to an information group chosen to be delivered by the information storage and playback device beforehand, from the information delivery device to the information storage and playback device through the information communicating means, and storing the transmitted partial information of the delivery information which belongs to the information group in the information storage and playback device;
transmitting partial information of delivery information, which belongs to one of information groups prioritized and sorted out according to a past record of a user of the information storage and playback device, from the information delivery device to the information storage and playback device through the information communicating means, and storing the transmitted partial information of the delivery information, which belongs to one of the information groups prioritized and sorted out according to the past record of the user of the information storage and playback device, in the information storage and playback device; or
transmitting partial information of delivery information, which belongs to one of information groups prioritized and sorted out according to past records of a plurality of users of the information storage and playback devices, from the information delivery device to the information storage and playback device through the information communicating means, and storing the transmitted partial information of the delivery information, which belongs to one of the information groups prioritized and sorted out according to the past records of the users of the information storage and playback devices, in the information storage and playback device.

20. The method for delivering information as claimed in claim 18, wherein the step of storing the partial information of the delivery information in the information storage and playback device beforehand includes a step of:
connecting a storage medium, in which the partial information of the delivery information is set up by the information delivery device beforehand, to the information storage and playback device, or transmitting the partial information of the delivery information which is set up by the information delivery device beforehand from the information delivery device to the information storage and playback device through the information communicating means and storing the transmitted part of the information of the delivery information in the information storage and playback device;
transmitting the partial information of the delivery information, which belongs to an information group chosen to be delivered by the information storage and playback device beforehand, from the information delivery device to the information storage and playback device through the information communicating means, and storing the transmitted partial information of the delivery information which belongs to the information group in the information storage and playback device;
transmitting partial information of delivery information, which belongs to one of information groups prioritized and sorted out according to a past record of a user of the information storage and playback device, from the information delivery device to the information storage and playback device through the information communicating means, and storing the transmitted partial information of the delivery information, which belongs to one of the information groups prioritized and sorted out according to the past record of the user of the information storage and playback device, in the information storage and playback device; or
transmitting partial information of delivery information, which belongs to one of information groups prioritized and sorted out according to past records of a plurality of users of the information storage and playback devices, from the information delivery device to the information storage and playback device through the information communicating means, and storing the transmitted partial information of the delivery information, which belongs to one of the information groups prioritized and sorted out according to the past records of the users of the information storage and playback devices, in the information storage and playback device.

21. The method for delivering information as claimed in claim 17, wherein:
the partial information of the delivery information, which is transmitted form the information delivery device to the information storage and playback device through the information communicating means and is received and stored in the information storage and playback device, is renewed if necessary; and
the step of storing the partial information of the delivery information in the information storage and playback device beforehand includes a step of:
connecting a storage medium, in which the partial information of the delivery information is set up by the information delivery device beforehand, to the information storage and playback device, or transmitting the partial information of the delivery information which is set up by the information delivery device beforehand from the information delivery device to the information storage and playback device through the information communicating means and storing the transmitted part of the information of the delivery information in the information storage and playback device;
transmitting the partial information of the delivery information, which belongs to an information group chosen to be delivered by the information storage and playback device beforehand, from the information delivery device to the information storage and playback device through the information communicating means, and storing the transmitted partial information of the delivery information which belongs to the information group in the information storage and playback device;
transmitting partial information of delivery information, which belongs to one of information groups prioritized and sorted out according to a past record of a user of the information storage and playback device, from the information delivery device to the information storage and playback device through the information communicating means, and storing the transmitted partial information of the delivery information, which belongs to one of the information groups prioritized and sorted out according to the past record of the user of the information storage and playback device, in the information storage and playback device; or
transmitting partial information of delivery information, which belongs to one of information groups prioritized and sorted out according to past records of a plurality of users of the information storage and playback devices, from the information delivery device to the information storage and playback device through the information communicating means, and storing the transmitted partial information of the delivery information, which belongs to one of the information groups prioritized and sorted out according to the past records of the users of the information storage and playback devices, in the information storage and playback device.

22. The method for delivering information as claimed in claim 18, wherein:
the partial information of the delivery information, which is transmitted form the information delivery device to the information storage and playback device through the information communicating means and is received and stored in the information storage and playback device, is renewed if necessary; and
the step of storing the partial information of the delivery information in the information storage and playback device beforehand includes a step of:
connecting a storage medium, in which the partial information of the delivery information is set up by the information delivery device beforehand, to the information storage and playback device, or transmitting the partial information of the delivery information which is set up by the information delivery device beforehand from the information delivery device to the information storage and playback device through the information communicating means and storing the transmitted part of the information of the delivery information in the information storage and playback device;
transmitting the partial information of the delivery information, which belongs to an information group chosen to be delivered by the information storage and playback device beforehand, from the information delivery device to the information storage and playback device through the information communicating means, and storing the transmitted partial information of the delivery information which belongs to the information group in the information storage and playback device;
transmitting partial information of delivery information, which belongs to one of information groups prioritized and sorted out according to a past record of a user of the information storage and playback device, from the information delivery device to the information storage and playback device through the information communicating means, and storing the transmitted partial information of the delivery information, which belongs to one of the information groups prioritized and sorted out according to the past record of the user of the information storage and playback device, in the information storage and playback device; or
transmitting partial information of delivery information, which belongs to one of information groups prioritized and sorted out according to past records of a plurality of users of the information storage and playback devices, from the information delivery device to the information storage and playback device through the information communicating means, and storing the transmitted partial information of the delivery information, which belongs to one of the information groups prioritized and sorted out according to the past records of the users of the information storage and playback devices, in the information storage and playback device.

23. A method for accounting for delivery information employing the information delivery system claimed in claims 1 to 16, wherein an information user making use of the information storage and playback device receives image, reflection or voice information from the information delivery device through the information communicating means, and an information provider, who delivers the image, reflection or voice information to the information user by employing the information delivery device, accounts for use of the image, reflection or voice information by the information user.

24. The method for accounting in the information storage and playback device as claimed in claim 23, wherein timing of the accounting is chosen from timing:
in parallel with a start of reproducing partial information of delivery information;
after a prescribed period of time from a start of reproducing the partial information of the delivery information; or
after reproducing a prescribed amount of the partial information of the delivery information from a start of reproducing the partial information of the delivery information.

25. The method for accounting in the information storage and playback device as claimed in claim 23, wherein timing of the accounting is chosen from timing:
in parallel with a start of reproducing remaining information of delivery information;
after a prescribed period of time from a start of reproducing the remaining information of the delivery information; or
after reproducing a prescribed amount of the remaining information of the delivery information from a start of reproducing the remaining information of the delivery information.

26. The method for accounting in the information storage and playback device as claimed in claim 23, wherein timing of the accounting is chosen from timing:
in parallel with a finish of reproducing remaining information of delivery information; or
after a prescribed time of a finish of reproducing the remaining information of the delivery information.

27. The method for accounting in the information storage and playback device as claimed in claim 23, wherein timing of the accounting is chosen from timing:
in parallel with a start of transmitting remaining information of delivery information;
after a prescribed time of a start of transmitting the remaining information of the delivery information; or
after transmitting a prescribed amount of the remaining information of the delivery information from a start of transmitting the remaining information of the delivery information.
